(19) United States
(12) Patent Application Publication
(10) Pub. No.: US 2018/0068816 A1
(43) Pub. Date: Mar. 8, 2018

(54) BIOMETRIC IDENTIFICATION SYSTEM AND WAKE-UP METHOD THEREOF

(71) Applicant: Gingy Technology Inc., Hsinchu City (TW)

(72) Inventors: Yi-Chung Lo, Hsinchu City (TW); Shih-Ju Ho, Hsinchu City (TW)

(73) Assignee: Gingy Technology Inc., Hsinchu City (TW)

(21) Appl. No.: 15/402,233

(22) Filed: Jan. 10, 2017

Related U.S. Application Data
(60) Provisional application No. 62/382,785, filed on Sep. 2, 2016.

(30) Foreign Application Priority Data
Nov. 22, 2016 (TW) 105138310

(51) Int. Cl. H01H 47/00; G06K 9/00

(52) U.S. Cl. CPC H01H 47/00; G06K 2009/00939; G06K 9/00885; G06K 9/00013

(57) ABSTRACT

A biometric identification system including a sensor, a front end processing device, and a main processing device is provided. The sensor is configured to sense a trigger event, and output a sensing data according to the trigger event. The front end processing device is electrically coupled to the sensor. The front end processing device is configured to receive and analyze the sensing data. The front end processing device identifies whether the trigger event is triggered by a biological object to determine whether to output the sensing data. The main processing device is electrically coupled to the front end processing device. The main processing device is configured to determine whether to perform a wake-up operation according to whether the sensing data is received. In addition, a wake-up method is also provided.

### CROSS-REFERENCE TO RELATED APPLICATION

This application claims the priority benefits of U.S. provisional application Ser. No. 62/382,785, filed on Sep. 2, 2016 and Taiwan application serial no. 105138310, filed on Nov. 22, 2016. The entirety of each of the above-mentioned patent applications is hereby incorporated by reference herein and made a part of this specification.

### BACKGROUND OF THE INVENTION

### Field of the Invention

The invention relates to an identification system and a wake-up method thereof, and in particular, a biometric identification system and a wake-up method thereof.

### Description of Related Art

With the advance in the biometric identification technology, relevant applications of the biometric identification technology have become more and more prevalent in people's life. In particular, there are more and more applications relating to applying the biometric identification technology to protection of user data of personal computer equipment. Therefore, in an electronic apparatus equipped with the biometric identification technology, a main processing device or an operation system can usually be started by verifying a user's biological feature. Specifically, the biological feature is, for example, a fingerprint feature, an oxygen saturation feature, a vein feature, an iris feature, a blink count feature, an electrical conductivity feature, a touch count feature, or a touch pressure feature.

However, whenever the biological feature is verified, the main processing device of the electronic apparatus usually needs to consume more power to perform the verification operation. In other words, if any touch by mistake or touch by a quasi-biological object occurs, the electronic apparatus will waste power on the verification operation. Therefore, it is currently an important issue how to efficiently wakes up the main processing device of the electronic apparatus to lower erroneous sensing resulting from touches by mistake and thereby reduce power consumption of the electronic apparatus. In light of the above, the invention provides a number of solutions in the embodiments below.

### SUMMARY OF THE INVENTION

The invention provides a biometric identification system and a wake-up method thereof capable of determining whether a trigger event is triggered by a biological object through a front end processing device in advance to determine whether to output a sensing data to a main processing device to more efficiently wake up the main processing device.

The biometric identification system of the invention includes a sensor, a front end processing device, and a main processing device. The sensor is configured to sense a trigger event and output a sensing data according to the trigger event. The front end processing device is electrically coupled to the sensor. The front end processing device is configured to receive and analyze the sensing data such that the front end processing device identifies whether the trigger event is triggered by a biological object to determine whether to output the sensing data. The main processing device is electrically coupled to the front end processing device. The main processing device is configured to determine whether to perform a wake-up operation according to whether the sensing data is received.

The wake-up method of the invention is adaptable for a biometric identification system. The biometric identification system includes a sensor, a front end processing device, and a main processing device. The wake-up method includes the following steps: sensing a trigger event through the sensor and outputting a sensing data to the front end processing device according to the trigger event; analyzing the sensing data through the front end processing device to identify whether the trigger event is triggered by a biological object to determine whether to output the sensing data to the main processing device; and determining whether the main processing device performs a wake-up operation according to whether the sensing data is received.

In light of the above, the biometric identification system and the wake-up method of the embodiments of the invention identify whether the trigger event is triggered by the biological object through the front end processing device in advance and then determine whether to wake up the main processing device. Moreover, the biometric identification system and the wake-up method of the embodiments of the invention further include performing an exception identification operation. When the trigger event does not pass a preliminary identification of the front end processing device, the front end processing device further performs the exception identification operation to identify again whether the trigger event is triggered by the biological object according to the statisticized sensing data. Accordingly, the biometric identification system and the wake-up method of the embodiments of the invention can more efficiently wake up the main processing device to save power consumption.

To provide a further understanding of the aforementioned and other features and advantages of the invention, exemplary embodiments, together with the reference drawings, are described in detail below.

### BRIEF DESCRIPTION OF THE DRAWINGS

FIG. 1 is a schematic diagram illustrating a biometric identification system according to one embodiment of the invention.

FIG. 2 is a flowchart illustrating steps of a wake-up method according to one embodiment of the invention.

FIG. 3 is a schematic diagram illustrating a biometric identification system according to another embodiment of the invention.

FIG. 4 is a flowchart illustrating steps of a wake-up method according to another embodiment of the invention.

FIG. 5 is a schematic diagram illustrating a biometric identification system according to another embodiment of the invention.

FIG. 6 is a flowchart illustrating steps of a wake-up method according to another embodiment of the invention.

### DESCRIPTION OF THE EMBODIMENTS

A plurality of embodiments are provided below to describe the invention. However, the invention is not limited to the plurality of embodiments as illustrated. Moreover, adequate combinations are allowed among the embodiments. The term “electrically couple” used in the full text of the specification (including the claims) refers to any direct and indirect connection means. For example, if a first device is described to be electrically coupled to a second device in the text, it is interpreted that the first device is directly coupled to the second device, or that the first device is indirectly coupled to the second device through other devices or some connection means.

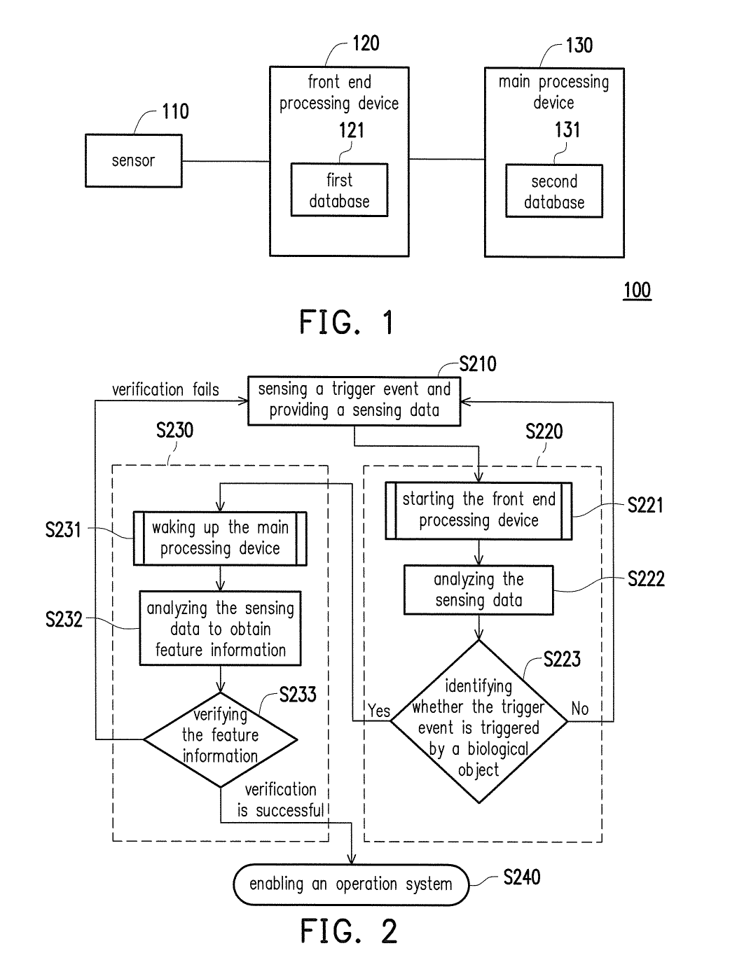

FIG. 1 is a schematic diagram illustrating a biometric identification system according to one embodiment of the invention. Referring to FIG. 1, a biometric identification system 100 includes a sensor 110, a front end processing device 120, and a main processing device 130. In the present embodiment, when a trigger event takes place, the biometric identification system 100 senses the trigger event through the sensor 110. The sensor 110 outputs a sensing data to the front end processing device 120 according to a result of sensing the trigger event. In the present embodiment, the front end processing device 120 is configured to analyze the sensing data to identify whether the trigger event is triggered by a biological object. The trigger event is triggered by the biological object, the front end processing device 120 outputs the sensing data to the main processing device 130 to wake up the main processing device 130. In other words, through the front end processing device 120, the biometric identification system 100 of the present embodiment determines in advance whether the trigger event is triggered by the biological object, thereby preventing the main processing device 130 from being woken up by a non-biological object. When the sensing data passes identification of the front end processing device 120, the main processing device 130 performs a wake-up operation and verifies the sensing data. Accordingly, the main processing device 130 of the present embodiment can be effectively used so as to avoid power waste.

For example, the front end processing device 120 of the present embodiment includes a first database 121 for storing an analysis program, an identification program, and a wake-up program, for example. When the sensor 110 senses the trigger event and wakes up the front end processing device 120, the front end processing device 120 executes the analysis program, the identification program, and the wake-up program in sequence according to the sensing data. Moreover, the main processing device 130 of the present embodiment includes a second database 131 for storing an analysis program, a verification program, and an enable program, for example. Next, when the front end processing device 120 wakes up the main processing device 130, the front end processing device 120 transmits the sensing data sensed by the sensor 110 to the main processing device 130. The main processing device 130 executes the analysis program, the verification program, and the enable program in sequence according to the sensing data. In other words, only when the sensing data of the trigger event passes determination of the front end processing device 120 will the biometric identification system 100 wake up the main processing device 130 to perform a biometric verification task.

In addition, in the present embodiment, the front end processing device 120 and the main processing device 130 are, for example, central processing units (CPU) including one single core or multiple cores, or programmable microprocessors for a general or specific purpose, digital signal processors (DSP), programmable controllers, application specific integrated circuits (ASIC), programmable logic devices (PLD), other similar devices, or combinations of these devices. Moreover, the front end processing device 120 and the main processing device 130 respectively include a memory device. The memory device is, for example, a random access memory (RAM), a read-only memory (ROM), a flash memory, etc. that is configured to at least store the first database and the second database described in the embodiments of the invention. In addition, the first database and the second database store the algorithm programs and data described in the embodiments of the invention.

FIG. 2 is a flowchart illustrating steps of a wake-up method according to one embodiment of the invention. Referring to FIG. 1 and FIG. 2 at the same time, in the present embodiment, the biometric identification system 100 is configured to execute the following steps. In step S210, when the sensor 110 senses a trigger event, the sensor 110 provides a sensing data to the front end processing device 120. In step S220, the front end processing device 120 analyzes the sensing data in advance to identify whether the trigger event is triggered by a biological object. In step S230, if the trigger event is triggered by the biological object, the front end processing device 120 wakes up the main processing device 130 and outputs an identification data to the main processing device 130. The main processing device 130 verifies feature information in the sensing data to determine whether to execute step S240. In step S240, the main processing device 130 enables or logs into an operation system (OS).

Step S220 is further described. In step S221, when the sensor 110 senses the sensing data, the sensor 110 starts the front end processing device 120. In step S222, the front end processing device 120 executes, for example, an analysis program to analyze the sensing data. Next, in step S223, the front end processing device 120 executes, for example, an identification program to identify whether the trigger event is triggered by the biological object to determine whether to execute a wake-up program to wake up the main processing device 130.

Step S230 is further described. In step S231, when the front end processing device 120 wakes up the main processing device 130, the main processing device 130 receives the sensing data provided by the front end processing device 120. In step S232, the main processing device 130 executes, for example, an analysis program to obtain the feature information in the sensing data. Next, in step S233, the main processing device 130 executes, for example, a verification program to verify the feature information. The main processing device 130 determines whether to enable (or log into) the operation system according to a verification result.

It shall be noted that the analysis and verification steps described in step S230 above refer to comparing the feature information in the sensing data sensed by the sensor 110 based on a plurality of entries of default feature information stored in advance in the second database 131. For example, the main processing device 130 determines whether a user providing the feature information has the right to access the operation system of an electronic apparatus. However, the common knowledge in the art provides sufficient teachings, suggestions, and implementation descriptions for the implementation of analysis and verification of the feature information, which is thus not repeatedly described here.

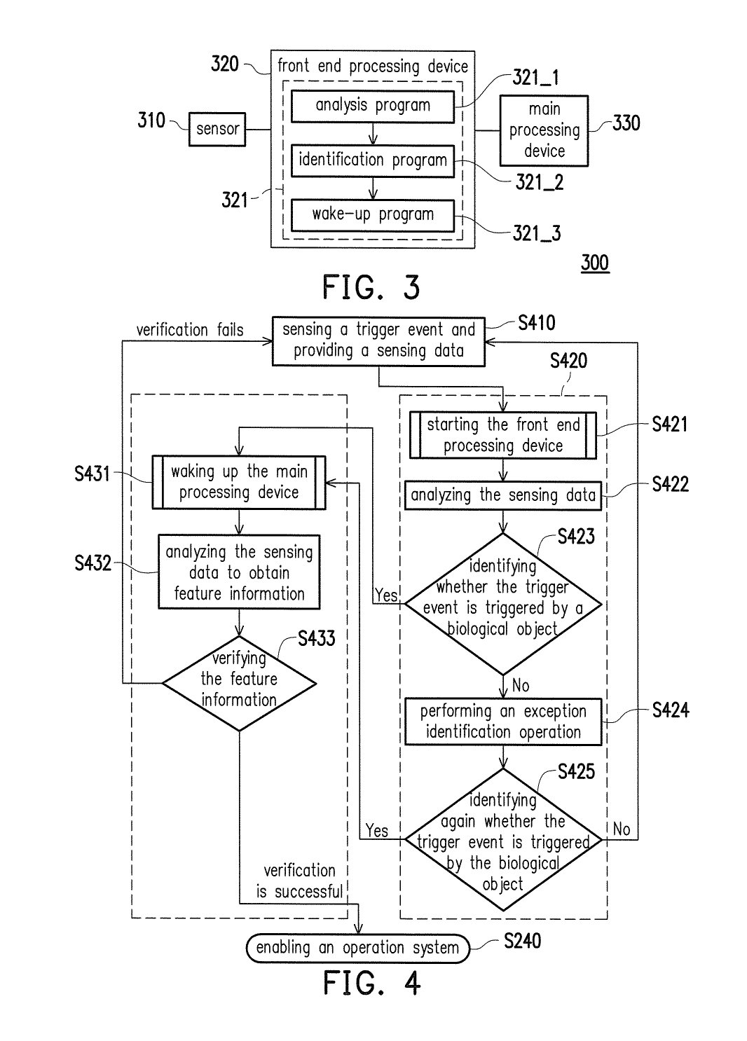

FIG. 3 is a schematic diagram illustrating a biometric identification system according to another embodiment of the invention. Referring to FIG. 3, a biometric identification system 300 includes a sensor 310, a front end processing device 320, and a main processing device 330. The front end processing device 320 is configured to execute an analysis program 321_1, an identification program 321_2, and a wake-up program 321_3 in sequence. In the present embodiment, the biometric identification system 300 is configured to identify biological features or behavioral features including a fingerprint feature, a vein feature, an iris feature, a blink count feature, an oxygen saturation feature, an electrical conductivity feature, a touch count feature, and a touch pressure feature, for example. Therefore, the sensor 310 is, for example, an image sensor, an electrical conductivity sensor, a pressure sensor, etc. In the present embodiment, the sensor 310 is configured to sense a trigger event, and the front end processing device 320 executes an analysis program and an identification program to identify whether the trigger event is triggered by the biological object, and then it is determined whether to wake up the main processing device 330.

Taking the fingerprint feature as an example, the sensor 310 is an image sensor. The sensor 310 is configured to capture a fingerprint image, and the front end processing device 320 executes the analysis program 321_1 to analyze the fingerprint image to obtain fingerprint feature information. Specifically, the front end processing device 320 executes the identification program 321_2 to determine whether lengths of a plurality of fingerprint lines meet specific lengths or satisfy specific length relationships to determine whether the trigger event is triggered by the biological object having a true fingerprint feature. In other words, the biometric identification system 300 preliminarily analyzes and identifies the fingerprint feature information provided by the trigger event in advance and then determines whether to execute the wake-up program 321_3 to wake up the main processing device.

Taking the oxygen saturation feature as an example, the sensor 310 is an image sensor (e.g., a photoelectron sensor described in U.S. patent application Ser. No. 14/978,237 entitled “Fingerprint Identification Apparatus for Simultaneously Identifying Finger Image and Oxygen Saturation” previously filed by the Applicant), but is not limited hereto. The sensor 310 is configured to capture a finger image, and the front end processing device 320 executes the analysis program 321_1 to analyze the finger image to obtain an oxygen saturation graph of a finger (e.g., a change in a percentage of oxygen content in blood of oxygenated hemoglobin (HbO2) and deoxyhemoglobin (Hb) of blood). The front end processing device 320 executes the identification program 321_2 to determine a level of oxygen saturation according to the oxygen saturation graph to determine whether the trigger event is triggered by an actual finger. In other words, the biometric identification system 300 preliminarily analyzes and determines the oxygen saturation feature information provided by the trigger event in advance and then determines whether to execute the wake-up program 321_3 to wake up the main processing device.

Taking the electrical conductivity feature as an example, the sensor 310 is an electrical conductivity sensor. The sensor 310 is configured to sense an electrical conductivity of a finger, and the front end processing device 320 analyzes the electrical conductivity of the finger. The front end processing device 320 executes the analysis program 321_1 to analyze whether a measure of the electrical conductivity of the finger falls in a human value range and executes the identification program 321_2 to determine whether the trigger event is triggered by an actual finger. In other words, the biometric identification system 300 preliminarily analyzes and determines the electrical conductivity feature information provided by the trigger event and then determines whether to execute the wake-up program 321_3 to wake up the main processing device.

Taking the touch pressure feature as an example, the sensor 310 is a pressure sensor. The sensor 310 is configured to sense a pressure magnitude or a touch count of finger presses, and the front end processing device 320 executes the analysis program 321_1 to analyze the touch pressure magnitude or the touch count of the finger presses. The front end processing device 320 analyzes whether the touch pressure magnitude or the touch count of the finger falls in a specific range of magnitude or specific count and executes the identification program 321_2 to identify whether the trigger event is triggered by an actual finger. In other words, the biometric identification system 300 preliminarily analyzes and determines the information of the touch count feature or touch pressure feature provided by the trigger event in advance and then determines whether to execute the wake-up program 321_3 to wake up the main processing device.

It shall be noted that the analysis program, the identification program, and the wake-up program above are modules that are built in the first database 321 in advance, and the analysis program, the identification program, and the wake-up program may be correspondingly designed according to embodiments of different biological features or different behavioral features and are not limited to the exemplary embodiments described above.

FIG. 4 is a flowchart illustrating steps of a wake-up method according to another embodiment of the invention. Referring to FIG. 1 and FIG. 4 at the same time, in the present embodiment, the biometric identification system 100 is configured to execute the following steps. In step S410, when the sensor 110 senses a trigger event, the sensor 110 provides a sensing data to the front end processing device 120. In step S420, the front end processing device 120 analyzes the sensing data in advance to identify whether the trigger event is triggered by a biological object. In step S430, if the trigger event is triggered by the biological object, the front end processing device 120 wakes up the main processing device 130 and outputs an identification data to the main processing device 130. The main processing device 130 verifies feature information in the sensing data to determine whether to execute step S440. In step S440, the main processing device 130 enables or logs into an operation system (OS). However, reference may be made to the embodiment of FIG. 2 as described above for the implementation of each step in the wake-up method of the present embodiment, which are thus not repeatedly described here.

It shall be noted that the wake-up method of the present embodiment differs from the embodiment of FIG. 2 in that step S420 of the present embodiment further includes an exception determination procedure. Specifically, in step S423, the front end processing device 120, for example, executes the identification program to identify whether the trigger event is triggered by the biological object to determine whether to execute the wake-up program to wake up the main processing device 130. However, if the front end processing device 120 is unable to identify whether the trigger event is triggered by the biological object, the front end processing device 120 executes step S424. In step S424, the front end processing device 120 performs an exception identification operation. In step S425, the front end processing device 120 identifies again whether the trigger event is triggered by the biological object to determine whether to execute the wake-up program to wake up the main processing device 130.

Specifically, in the present embodiment, the exception identification operation applies when the front end processing device 120 determines that the feature information obtained by the sensor 110 does not satisfy conditions of specific biological features or specific behavioral features (e.g., the exemplary biological features and behavioral features illustrated in the embodiment of FIG. 3). In that case, the front end processing device 120 of the present embodiment further performs the exception identification operation to identify again whether the trigger event is triggered by the biological object to lower a probability of misjudgment of the sensor 110. In the exception identification operation of the present embodiment, the front end processing device 110, for example, statisticizes and analyzes a plurality of sensing data obtained in the trigger event in a predetermined time to confirm whether the trigger event is triggered by the biological object according to the sensing data in the predetermined time. In other words, the exception identification operation, for example, statisticizes the plurality of sensing data through algorithms to generate an integrated sensing data, and then determines whether the trigger event is triggered by the biological object by re-analyzing the integrated sensing data.

For example, when the user touches three times in a predetermined time of 20 seconds and none passes the preliminary determination of the front end processing device 120, the biometric identification system 100 performs the exception identification operation to statisticize and analyze/compare the three consecutive touch behaviors in 20 seconds to re-determine whether the trigger event is triggered by the biological object. However, the method of re-determination may be identical to the method in step S423 and is thus not repeatedly described here. In the present embodiment, the purpose of the exception identification operation is to statisticize touch behaviors of consecutive times to integrate a plurality of sensing data to further determine whether the trigger event is triggered by the biological object.

For another example, when the biometric identification system is unable to determine whether the trigger event is triggered by the biological object, the biometric identification system 100 performs the exception identification operation to actively extract and store a biological feature image (e.g., fingerprint, oxygen saturation, and other data) generated when the user touches the sensor 110. If the sensor 110 does not sense a new biological feature image in a predetermined time, the biometric identification system 100 erases the sensing data to release storage space of the memory. However, if in a predetermined time of 5 to 20 seconds, for example, the sensor 110 senses fingerprint feature images for a plurality of times, which, however, do not pass the preliminary determination of the front end processing device 120, the front end processing device 120 statisticizes and analyzes/compares the data of the fingerprint feature images to re-determine whether the trigger event is triggered by the biological object. If the front end processing device 120 still determines that the trigger event is not triggered by the biological object, the front end processing device 120 erases the previously stored sensing data to release space of the memory.

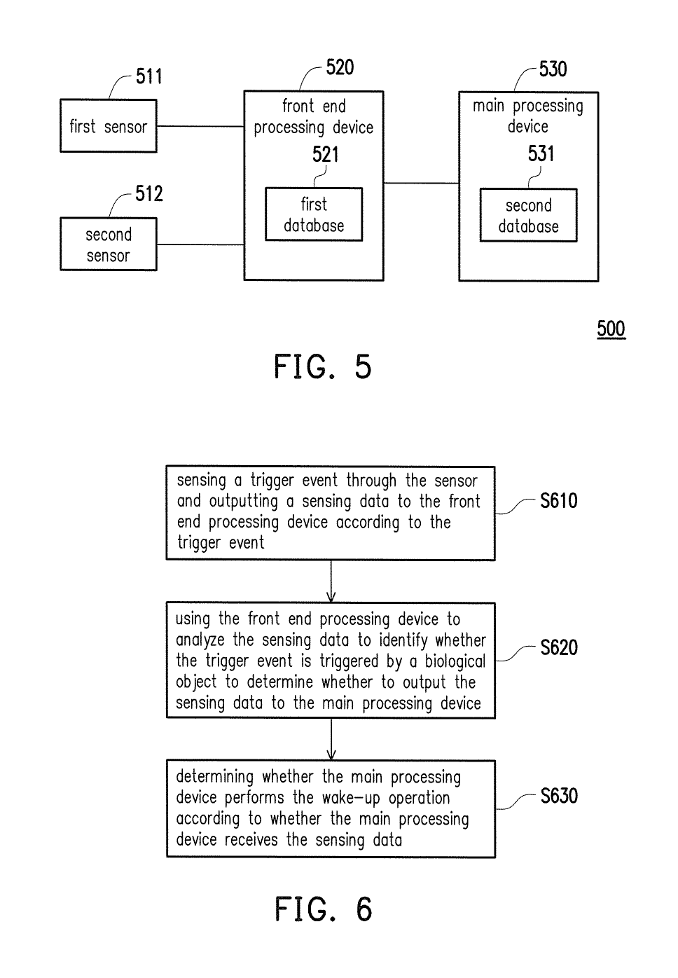

In one embodiment, the exception identification operation may also be implemented in the form of hardware. For example, the biometric identification system further includes another sensor. Specifically, FIG. 5 is a schematic diagram illustrating a biometric identification system according to another embodiment of the invention. Referring to FIG. 5, a biometric identification system 500 includes a first sensor 511, a second sensor 512, a front end processing device 520, and a main processing device 530. In the present embodiment, when a trigger event takes place, the biometric identification system 500 senses the trigger event through the first sensor 511. The first sensor 511 outputs a sensing data to the front end processing device 520 according to a result of sensing the trigger event. In the present embodiment, the front end processing device 520 is configured to analyze the sensing data to identify whether the trigger event is triggered by a biological object. If the trigger event is triggered by the biological object, the front end processing device 520 outputs the sensing data to the main processing device 530 to wake up the main processing device 530.

It shall be noted that if the front end processing device 520 first identifies that the trigger event is not triggered by the biological object, the front end processing device 520 obtains another sensing data through the second sensor 512. In the present embodiment, the second sensor 512 is, for example, a temperature sensor. The front end processing device 520 determines whether a temperature value of the trigger event falls in a range of human body temperature to re-determine whether the trigger event is triggered by the biological object.

FIG. 6 is a flowchart illustrating steps of a wake-up method according to another embodiment of the invention. Referring to FIG. 1 and FIG. 6, the method of the present embodiment is at least applicable to the biometric identification system 100 of FIG. 1, wherein the biometric identification system 100 includes a sensor 110, a front end processing device 120, and a main processing device 130. The wake-up method of the present embodiment at least includes the following steps. In step S610, the biometric identification system 100 senses a trigger event through the sensor 110 and outputs a sensing data to the front end processing device 120 according to the trigger event. In step S620, the biometric identification system 100 uses the front end processing device 120 to analyze the sensing data to identify whether the trigger event is triggered by a biological object to determine whether to output the sensing data to the main processing device 130. In step S630, the biometric identification system 100 determines whether the main processing device 130 performs the wake-up operation according to whether the main processing device 130 receives the sensing data.

In addition, the foregoing embodiments of FIG. 1 to FIG. 5 provide sufficient teachings, suggestions, and implementation descriptions for other specific technical features and implementation of the wake-up method of the present embodiment, which are thus not repeatedly described here.

In summary of the above, the biometric identification system and the wake-up method of the embodiments of the invention identify whether the trigger event is triggered by the biological object in advance through the front end processing device, and further include performing the exception identification operation to enhance accuracy of identification. Moreover, only when the trigger event sensed by the sensor passes the identification of the front end processing device will the front end processing device wake up the main processing device. Accordingly, the biometric identification system and the wake-up method of the embodiments of the invention can more efficiently wake up the main processing device to save power consumption.

Although the invention is disclosed in the embodiments above, the embodiments are not meant to limit the invention. Any person skilled in the art may make slight modifications and variations without departing from the spirit and scope of the invention. Therefore, the protection scope of the invention shall be defined by the claims attached below.

What is claimed is:

1. A biometric identification system comprising:
a sensor, configured to sense a trigger event, and output a sensing data according to the trigger event;
a front end processing device, electrically coupled to the sensor, configured to receive and analyze the sensing data such that the front end processing device identifies whether the trigger event is triggered by a biological object to determine whether to output the sensing data; and
a main processing device, electrically coupled to the front end processing device, configured to determine whether to perform a wake-up operation according to whether the sensing data is received.

2. The biometric identification system according to claim 1, wherein the front end processing device performs an identification operation to analyze whether the sensing data comprises feature information and determine whether the feature information satisfies a biological feature or a behavioral feature, such that the front end processing device identifies whether the trigger event is triggered by the biological object.

3. The biometric identification system according to claim 2, wherein the front end processing device is further configured to perform an exception identification operation to identify again whether the trigger event is triggered by the biological object, when the front end processing device determines that the feature information does not satisfy the biological feature or the behavioral feature.

4. The biometric identification system according to claim 3, wherein the exception identification operation comprises statisticizing and analyzing a plurality of sensing data of the trigger event in a predetermined time by the front end processing device to confirm whether the trigger event is triggered by the biological object according to the plurality of sensing data in the predetermined time.

5. The biometric identification system according to claim 3, wherein the exception identification operation comprises sensing the trigger event through another sensor by the front end processing device and outputting another sensing data according to the trigger event, wherein the front end processing device analyzes the another sensing data to re-identify whether the trigger event is triggered by the biological object.

6. The biometric identification system according to claim 5, wherein the another sensor is a temperature sensor and the front end processing device analyzes a temperature sensing value of the trigger event to determine whether the temperature sensing value falls in a specific temperature range to determine whether the trigger event is triggered by the biological object.

7. The biometric identification system according to claim 2, wherein the sensor is an image sensor and the biological feature is a fingerprint feature, an oxygen saturation feature, a vein feature, an iris feature, or a blink count feature.

8. The biometric identification system according to claim 2, wherein the sensor is an electrical conductivity sensor and the biological feature is an electrical conductivity feature.

9. The biometric identification system according to claim 2, wherein the sensor is a pressure sensor and the behavioral feature is a touch count feature or a touch pressure feature.

10. The biometric identification system according to claim 1, wherein the main processing device performs a biometric verification operation when the main processing device receives the sensing data to determine whether to enable an operation system according to a biometric verification result.

11. A wake-up method of a biometric identification system, adaptable for a biometric identification system comprising a sensor, a front end processing device, and a main processing device, the wake-up method comprising:
sensing a trigger event through the sensor and outputting a sensing data to the front end processing device according to the trigger event;
analyzing the sensing data through the front end processing device to identify whether the trigger event is triggered by a biological object to determine whether to output the sensing data to the main processing device; and
determining whether the main processing device performs a wake-up operation according to whether the sensing data is received.

12. The wake-up method according to claim 11, wherein the step of identifying whether the trigger event is triggered by the biological object comprises:
analyzing whether the sensing data comprises feature information through the front end processing device; and
determining whether the feature information satisfies a biological feature or a behavioral feature through the front end processing device to identify whether the trigger event is triggered by the biological object.

13. The wake-up method according to claim 12, wherein the step of identifying whether the trigger event is triggered by the biological object comprises:
performing an exception identification operation through the front end processing device to identify again whether the trigger event is triggered by the biological object.

14. The wake-up method according to claim 13, wherein the step of performing the exception identification operation comprises:
statisticizing and analyzing a plurality of sensing data of the trigger event in a predetermined time through the front end processing device to confirm whether the trigger event is triggered by the biological object according to the sensing data in the predetermined time.

15. The wake-up method according to claim 13, wherein the step of performing the exception identification operation comprises:
sensing the trigger event through another sensor and outputting another sensing data according to the trigger event; and
analyzing the another sensing data through the front end processing device to re-identify whether the trigger event is triggered by the biological object.

16. The wake-up method according to claim 15, wherein the another sensor is a temperature sensor and the step of analyzing the another sensing data comprises:
analyzing a temperature sensing value of the trigger event through the front end processing device to determine whether the temperature sensing value falls in a specific temperature range to determine whether the trigger event is triggered by the biological object.

17. The wake-up method according to claim 12, wherein the sensor is an image sensor and the biological feature is a fingerprint feature, an oxygen saturation feature, a vein feature, an iris feature, or a blink count feature.

18. The wake-up method according to claim 12, wherein the sensor is an electrical conductivity sensor and the biological feature is an electrical conductivity feature.

19. The wake-up method according to claim 12, wherein the sensor is a pressure sensor and the behavioral feature is a touch count feature or a touch pressure feature.

20. The wake-up method according to claim 11, further comprising:
performing a biometric verification operation through the main processing device when the main processing device receives the sensing data to determine whether to enable an operation system according to a biometric verification result.
